(19) United States
(12) Patent Application Publication
(10) Pub. No.: US 2016/0243573 A1
(43) Pub. Date: Aug. 25, 2016

(54) LINE MARKING APPARATUS WITH NOZZLE FLUSHING ARRANGEMENT

(71) Applicant: FLEET (LINE MARKERS) LIMITED, Malvern (GB)

(72) Inventor: Iain Peter McGuffie, Nr Bromyard (GB)

(73) Assignee: FLEET (LINE MARKERS) LIMITED, Malvern (GB)

(21) Appl. No.: 15/027,230

(22) PCT Filed: Oct. 6, 2014
(86) PCT No.: PCT/EP2014/071304

§ 371 Date: Apr. 4, 2016

(30) Foreign Application Priority Data
Oct. 7, 2013 (GB) 1317707.6

(51) Int. Cl. B05B 15/02; E01C 23/22; B05B 9/00; B05B 9/047; B05B 9/04

(52) U.S. Cl. CPC B05B 15/025; B05B 9/047; B05B 9/0403; B05B 9/007; E01C 23/22

(57) ABSTRACT

A line marking apparatus comprises a nozzle for dispensing line marking material, a first pump for supplying line marking material from a source to the nozzle, and a nozzle flushing arrangement. The nozzle flushing arrangement comprises a reservoir for a flushing fluid, and means selected from a syringe assembly and a second pump for conveying flushing fluid from the reservoir and for delivering the fluid under pressure to the nozzle.

This invention relates to a line marking apparatus including a nozzle flushing arrangement.

It is conventional practice in line marking apparatus, once the apparatus has been used and is to be stored, to flush the line marking material out of the delivery system to prevent blockages occurring, especially in the nozzle. The delivery system generally includes a pump and a line connecting the pump to a nozzle and can additionally include a tank or other storage means for the line marking material and a line for conducting the line marking material from the tank to the pump.

A separate source of water or other flushing fluid is generally used to replace the line marking material entering the pump in order to flush the line marking material from the apparatus, especially the nozzle, although it is also possible to add water to the empty storage means for line marking material.

A disadvantage associated with such flushing arrangements is that a significant volume of water, generally several litres, is required to flush the pump, nozzle and connecting lines. Not only does such a volume of water need to be carried with the line marking apparatus, in some cases in a separate tank provided as part of the apparatus, but the water used for flushing needs to be disposed of. Consequently, a user tends not to use such a flushing arrangement when the line marking apparatus is to be left standing for a relatively short time. Nevertheless, it is quite possible for the line marking material to cause the nozzle to block even after a short period of non-use.

It is therefore an object of the present invention to provide line marking apparatus incorporating a nozzle flushing arrangement which overcomes, or at least ameliorates, the above disadvantages.

According to one aspect of the present invention there is provided a line marking apparatus comprising: a nozzle for dispensing line marking material; a first pump for supplying line marking material from a source to the nozzle; and a nozzle flushing arrangement comprising a reservoir for a flushing fluid, and means selected from a syringe assembly and a second pump for conveying flushing fluid from the reservoir and for delivering the fluid under pressure to the nozzle.

The apparatus may include a non-return valve for preventing flow of flushing fluid from the nozzle towards the reservoir. The non-return valve may be positioned adjacent to the nozzle.

When the means for conveying the flushing fluid to the nozzle comprises a syringe assembly, the syringe assembly may be adapted to deliver a predetermined volume of flushing fluid.

The syringe assembly may include a single syringe.

Alternatively, the syringe assembly may include dual syringes, for example as a dual syringe assembly. In such a case, a first of the dual syringes may have a greater cross-sectional area than a second of the syringes. The first and second syringes may be concentric.

In the case of concentric syringes, an outer syringe may be slidably mounted within an outer cylinder and may itself be in the form of an inner cylinder. The outer syringe may include a piston which slidingly seals against an inner surface of the outer cylinder. The piston may be formed with an aperture, for example a central aperture, to allow flushing fluid to pass into and out of the inner cylinder. The outer cylinder may have an outlet for conducting flushing fluid to the nozzle.

An inner syringe may be slidably mounted within the inner cylinder forming part of the outer syringe. The inner syringe may include a piston which slidingly seals against the inner surface of the inner cylinder of the outer syringe.

The or each syringe may be provided with an operating handle.

The syringe may include a non-return valve to allow flushing fluid to pass into, but not out of, the syringe from the reservoir.

Alternatively, when the means for conveying the flushing fluid to the nozzle comprises a second pump, the second pump may be adapted to deliver a predetermined volume of flushing fluid, for example by including control means for activating the second pump for a predetermined time or by using a second pump which is capable of dispensing a predetermined volume.

The flushing fluid may comprise water. If desired, an anti-freeze may be added to the water.

The nozzle flushing arrangement may be connected to the remainder of the line marking apparatus downstream of the first pump, for example adjacent to, or at, the nozzle.

The line marking apparatus may include a further reservoir for line marking material. The further reservoir may include a self-sealing releasable coupling for conducting line marking fluid to the nozzle by way of the first pump. A non-return valve may be provided between the first pump and the nozzle. In such a case, the nozzle flushing arrangement may be connected to the remainder of the line marking apparatus downstream of the non-return valve between the first pump and the nozzle. The first pump may form part of a recirculation system, the recirculation system further including a pressure release valve.

For a better understanding of the present invention and to show more clearly how it may be carried into effect reference will now be made, by way of example, to the accompanying drawings in which:

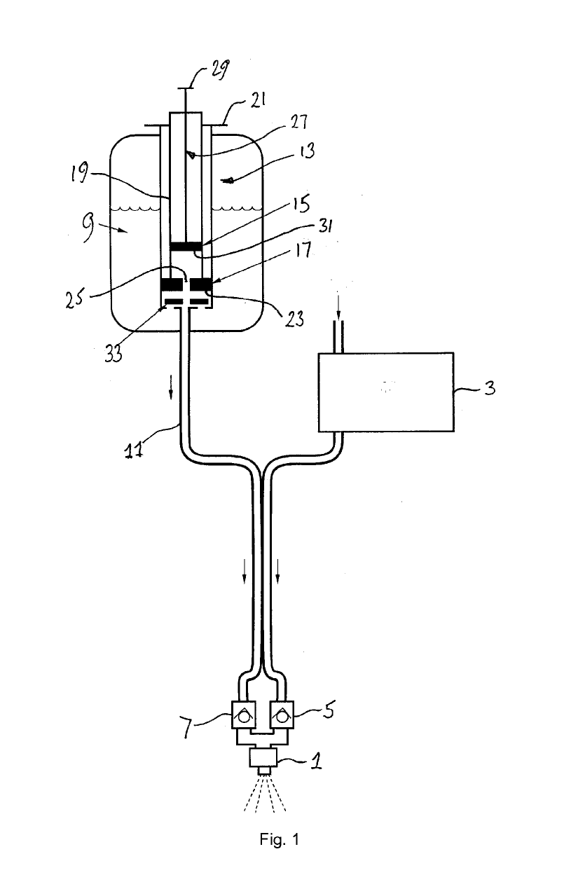

FIG. 1 is a diagrammatic illustration of one embodiment of a nozzle flushing arrangement for use in a line marking apparatus;

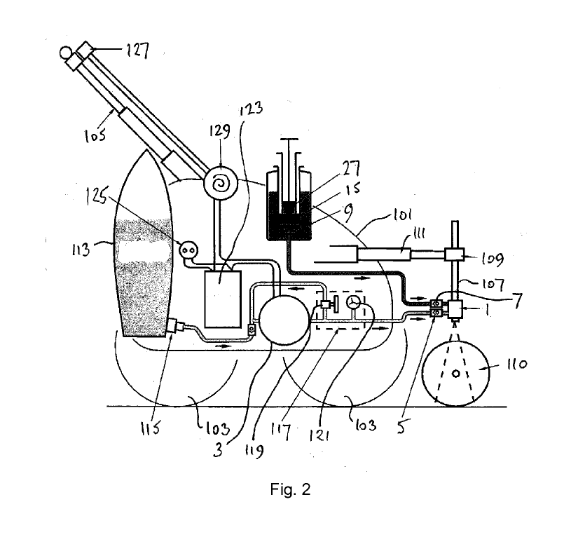

FIG. 2 shows a line marking apparatus including a nozzle flushing arrangement;

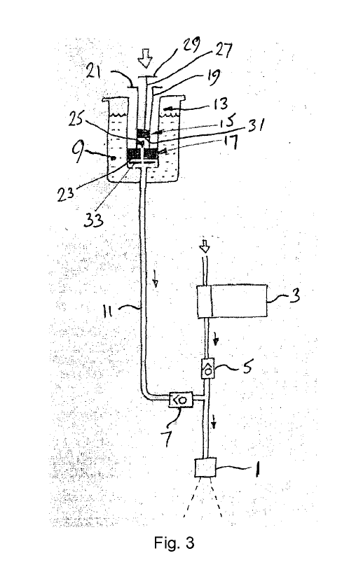

FIG. 3 shows a modification of the nozzle flushing arrangement shown in FIG. 1; and

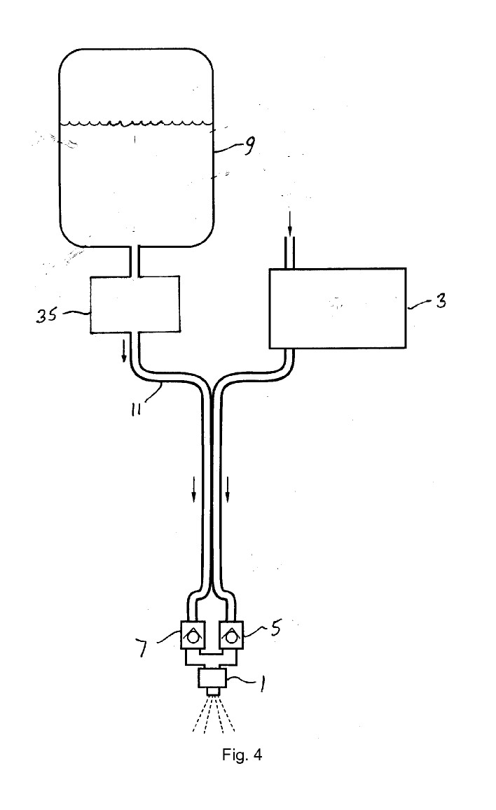

FIG. 4 shows a further modification of the nozzle flushing arrangement shown in FIG. 1.

FIG. 1 shows a nozzle 1 of a line marking apparatus which also includes a pump 3 for supplying line marking material from a source (not shown) to the nozzle 1 by way of a non-return valve 5. A nozzle flushing arrangement supplies water to the nozzle 1 by way of a separate non-return valve 7 which is connected to a reservoir 9 for water. A line 11 for conducting the water passes into the reservoir 9 and is connected to a syringe assembly 13. In the embodiment shown in FIG. 1 the syringe assembly 13 is in the form of a dual syringe with two concentric syringes.

An outer syringe 15 is slidably mounted within a cylinder 17 and is itself in the form of a cylinder 19. The outer syringe 15 is provided with an operating handle 21 at an exposed end and with a piston 23 which slidingly seals against the inner surface of the outer cylinder 17. Piston 23 is formed with a central aperture 25 to allow water to pass into and out of the cylinder 19.

An inner syringe 27 is slidably mounted within the cylinder 19 forming part of the outer syringe 15 and includes an operating handle 29 at an exposed end and a piston 31 which slidingly seals against the inner surface of the inner cylinder 19 of the outer syringe 15.

The outer cylinder 17 has an outlet at a closed end thereof which is connected to the line 11 for conducting water to the nozzle 1. A non-return (one-way) valve 33 is provided in the region of the outer cylinder between the piston 23 and the outlet so as to allow water to pass into the outer and inner cylinders from the reservoir 9, but only allowing water to exit through the line 11.

In use of the nozzle flushing arrangement of FIG. 1, when the line marking apparatus has been used and is to be left for a relatively short time it is desirable to flush the line marking material out of the nozzle 1 to prevent the nozzle becoming blocked. However, the time required for a full flushing operation is significant, as is the volume of water or other flushing fluid required. In distinction, the flushing operation is accomplished according to the present invention simply by the user pulling the operating handle 21 of the outer syringe 15 out of the outer cylinder 17 so as to draw water from the reservoir 9 into the cylinders 17 and 19. The operating handle 21 is then pushed towards the outer cylinder 17 so as to eject water from the outer syringe and into the line 11, through the non-return valve 7 and through the nozzle 1 and so flushing line marking material from the nozzle. Thus, the flushing arrangement is essentially independent of the line marking components and does not require any additional tools or accessories in order to carry out the flushing process.

The advantages of the nozzle flushing arrangement as shown in FIG. 1 are that the flushing arrangement is simple to use, that only a very small predetermined dose or volume of water is required (for example, less than about 50 ml compared with about 2 litres in the prior art) with the result that the reservoir 9 does not often require to be re-filled and/or that the size of the reservoir can be reduced compared with the prior art, and also that the small amount of flushing water (which contains flushed line marking material) can readily be disposed of, possibly even on a line that has been marked, resulting in a more environmentally-friendly flushing process. The small volume of flushing water used results in a correspondingly small volume of line marking material being lost in the flushing process, thus improving the economy of use of the line marking apparatus. Further, it remains possible to flush the line marking material from the nozzle even if the battery that is conventionally used to power the pump for dispensing both line marking material and flushing water is flat (discharged) and the pump is inoperable. The nozzle flushing arrangement of the present invention is not intended to replace conventional flushing of the line marking apparatus when the line marking apparatus is to be stored for any length of time. In this case it is still desirable to flush line marking material from the line marking apparatus, including the pump 3.

Even though the nozzle 1 may be flushed with water with the nozzle flushing arrangement of the present invention, the nozzle can still occasionally become blocked. In such situations, the inner syringe 27 is used. Because the inner syringe necessarily has a smaller diameter (and therefore a smaller cross-sectional area) than the outer syringe, it requires less effort to move the operating handle 29 and piston 31 so as to force water through the nozzle 1 and clear the blockage.

Where the nozzle flushing arrangement is to be used at low ambient temperatures where there is a possibility of the water freezing, an anti-freeze may be added to the reservoir 9. Additionally, because the flushing fluid does not pass through the pump 3 and therefore will not damage any components of the pump, the flushing fluid may have properties that are not compatible with components of the pump, for example a more aggressive flushing fluid may be employed. Because only a very small volume of the flushing fluid is used to flush the nozzle 1, it is not difficult to contain the flushing fluid, even when the flushing fluid is not environmentally friendly.

With regard to further potential modifications, one or both of the non-return valves 5 and 7 may be omitted.

FIG. 2 shows a line marking apparatus including the nozzle flushing arrangement of FIG. 1. The line marking apparatus shown in FIG. 2 comprises a housing 101, for example of plastics material, provided with four wheels 103 and a handle 105 which may, for example, be in the form of a telescopic handle. The line marking apparatus is provided with a spray head including a nozzle 1 which is adjustable upwardly and downwardly by means of a rod 107 passing through a housing 109, and a pair of adjustable line guide discs 110. The housing 109 is mounted at the free end of a telescopic boom 111 which allows the nozzle 1 to be retracted towards or into the housing 101 when not in use and to be extended from the housing 101 when the nozzle is to be used for marking a line.

Line marking material is stored in a reservoir 113 which in the illustrated embodiment is in the form of a disposable flexible bag. Line marking material exits from a lower region of the reservoir 113 by way of a self-sealing releasable coupling 115 which allows the reservoir to be exchanged and passes to a recirculation system based around pump 3. The recirculation system includes a manifold 117 including a pressure release valve 119 and a pressure gauge 121. Pump 3 is powered by a rechargeable battery 123 which is connected to a battery charging socket 125 and to an on-off switch 127 mounted on the handle 105 and including a cable recoil reel 129 for controlling the cable leading to the switch 127. Line marking material from the recirculation system passes through non-return valve 5 to nozzle 1, from where it is dispensed onto a surface to be marked.

When the line marking apparatus is to be left standing for a relatively short time (such as while the user takes a break), the nozzle 1 is flushed with water from reservoir 9 of the nozzle flushing arrangement (for example as shown and described in relation to FIG. 1) by means of the outer syringe 15. To this end, the nozzle flushing arrangement is connected to the remainder of the line marking apparatus downstream of the pump, for example downstream of the non-return valve 5. In particular, the nozzle flushing arrangement may be connected to the remainder of the line marking apparatus adjacent to, or (as illustrated in FIG. 1) at, the nozzle 1. If at any time the nozzle 1 should become blocked, then the inner syringe 27 can be used to apply greater fluid pressure in order to clear the blockage.

FIG. 3 shows a modification of the nozzle flushing arrangement of FIG. 1 and the same references are used to denote the same or similar components. As shown in FIG. 3, the non-return valves 5 and 7 are located at a greater distance from the nozzle 1. The effect of the non-return valves 5 and 7 is the same as the corresponding valves in FIG. 1, but a (slightly) greater volume of water is required to flush the nozzle. It should be noted, though, that the volume of water required is still small, for example less than 100 ml and possibly still less than 50 ml.

FIG. 4 shows a further modification of the nozzle flushing arrangement of FIG. 1 and the same references are used to denote the same or similar components. In FIG. 4 the outer and inner syringes are replaced by a flushing pump 35 which conveys water from the reservoir to the nozzle 1 by way of the non-return valve 7. In this embodiment of the present invention, the battery needs to have sufficient charge to operate the pump 35 in order to carry out the flushing operation. However, the volume of water used is still substantially lower that using the main pump 3 and the advantages associated with using only a small volume of flushing water still remain. It is still possible to dispense a predetermined volume of water by operating the pump for a predetermined time, for example by providing control means for activating the pump for such predetermined time, or by using a pump which can dispense a predetermined volume.

I claim:

1. A line marking apparatus comprising: a source of line marking material; a nozzle for dispensing the line marking material; marking material conduit, connected to the nozzle, for conveying the marking material to the nozzle; and a nozzle flushing arrangement comprising a reservoir for a flushing fluid and means for delivering the flushing fluid under pressure from the reservoir via a flushing fluid conduit to the nozzle, wherein the flushing fluid conduit is connected to the marking material conduit.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. The line marking apparatus of claim 1, wherein the flushing fluid conduit is connected to the marking material conduit at or adjacent to the nozzle.

33. The apparatus of claim 1, wherein the nozzle flushing arrangement is configured to deliver a predetermined volume of the flushing fluid.

34. The apparatus of claim 33, wherein the predetermined volume is less than 100 ml.

35. The apparatus of claim 33, wherein the predetermined volume is less than 50 ml.

36. The apparatus of claim 1, further comprising a non-return valve for preventing flow of flushing fluid from the nozzle towards the reservoir.

37. The apparatus of claim 1, wherein the means for delivering the flushing fluid under pressure to the nozzle comprises a syringe assembly.

38. The apparatus of claim 37, wherein the syringe assembly comprises dual syringes comprising a dual syringe assembly.

39. The apparatus of claim 38, wherein a first one of the dual syringes has a greater cross-sectional area than a second one of the syringes.

40. The apparatus of claim 39, wherein an outer syringe has the form of n inner cylinder and is slidably mounted within an outer cylinder.

41. The apparatus of claim 40, wherein the outer syringe includes a piston which slidingly seals against an inner surface of the outer cylinder.

42. The apparatus of claim 41, wherein the piston is formed with an aperture to allow flushing fluid to pass into and out of the inner cylinder.

43. The apparatus of claim 40, wherein an inner syringe is slidably mounted within the inner cylinder forming part of the outer syringe.

44. The apparatus of claim 43, wherein the inner syringe includes a piston which slidingly seals against the inner surface of the inner cylinder of the outer syringe.

45. The apparatus of claim 32, wherein the means for delivering the flushing fluid to the nozzle includes a first pump adapted to deliver a predetermined volume of flushing fluid.

46. The apparatus of claim 1, further comprising a further reservoir for line marking material, wherein the further reservoir comprises a self-sealing releasable coupling for conducting the line marking material to the nozzle by way of a second pump.

47. The apparatus of claim 46, wherein a non-return valve is provided between the second pump and the nozzle.

48. A method of flushing the nozzle of the line marking apparatus of claim 1, wherein the method comprises introducing flushing fluid under pressure into the marking material conduit.

49. The method of claim 48, comprising introducing the flushing fluid into the marking material conduit at or adjacent to the nozzle.

50. The method of claim 48, wherein the said flushing comprises introducing less than 100 ml of the flushing fluid into the marking material conduit.

51. The method of claim 48, wherein the said flushing comprises introducing less than 50 ml of the flushing fluid into the marking material conduit.
